(19) United States
(12) Patent Application Publication
(10) Pub. No.: US 2012/0242572 A1
(43) Pub. Date: Sep. 27, 2012

(54) SYSTEM AND METHOD FOR TRANSACTION OF SENSORY INFORMATION

(75) Inventors: Eun Seo Lee, Daejeon (KR); Bum Suk Choi, Daejeon (KR)

(73) Assignee: Electronics and Telecommunications Research Institute, Daejeon (KR)

(21) Appl. No.: 13/426,483

(22) Filed: Mar. 21, 2012

(30) Foreign Application Priority Data
Mar. 21, 2011 (KR) 10-2011-0025068
Feb. 23, 2012 (KR) 10-2012-0018522

(51) Int. Cl. G09G 5/00; G06K 9/00

(52) U.S. Cl. 345/156; 382/100

(57) ABSTRACT

A system and method for transaction of sensory information are provided. A sensory effect extraction apparatus of the system includes a sensory effect extraction unit to extract a sensory effect from an image content in accordance with a sensory effect extraction signal, and a sensory information transmission unit to transmit sensory information based on the extracted sensory effect.

### CROSS-REFERENCE TO RELATED APPLICATION

This application claims the benefit of Korean Patent Applications No. 10-2011-0025068, filed on Mar. 21, 2011 and No. 10-2012-0018522, filed on Feb. 23, 2012, in the Korean Intellectual Property Office, the disclosure of which is incorporated herein by reference.

### BACKGROUND

1. Field of the Invention

The present invention relates to a system and method for transaction of sensory information, and more particularly, to a sensory information transaction system and method for generation and transaction of various forms of sensory information associated with one content by generating the sensory information according to a standardized protocol.

2. Description of the Related Art

Recently, technologies for providing various sensory effects in association with multimedia content are being developed.

However, since sensory effects are extracted and transacted in accordance with different standards according to companies, when a plurality of companies intend to extract respectively different sensory effects, it is, in actuality, impractical to apply such a plurality of sensory effects.

Accordingly, there is a desire for a new method for standardizing a protocol or a transaction structure related to extraction and transaction of sensory effects.

### SUMMARY

An aspect of the present invention provides a system and method capable of generating various forms of sensory information in one image content by generating the sensory information according to a standardized protocol.

Another aspect of the present invention provides a system and method capable of preventing a transaction of sensory information which is not displayable by a device for displaying content, by transmitting information on the device using a standardized protocol.

According to an aspect of the present invention, there is provided a sensory effect extraction apparatus including a sensory effect extraction unit to extract a sensory effect from an image content in accordance with a sensory effect extraction signal, and a sensory information transmission unit to transmit sensory information based on the extracted sensory effect.

The sensory effect extraction request signal may include position information of the image content from which the sensory effect is to be extracted and reference region information to be extracted from the image content, reference time information for extraction of the sensory effect from the image content, type information of the sensory effect to be extracted from the image content, and extension region information corresponding to additional attribute extensions.

According to another aspect of the present invention, there is provided a sensory content providing apparatus of a sensory information transaction system, including a request signal receiving unit to receive, from a user terminal, a sensory content request signal which includes device capability information and user sensory preference information, and a content providing unit to provide the user terminal with sensory content corresponding to the sensory content request signal.

According to another aspect of the present invention, there is provided a sensory information transaction method including extracting a sensory effect from image content in accordance with a sensory effect extraction request signal, and transmitting sensory information based on the extracted sensory effect.

According to another aspect of the present invention, there is provided a sensory information transaction method including receiving, from a user terminal, a sensory content request signal which includes device capability information and user sensory preference information, and providing the user terminal with a sensory content corresponding to the sensory content request signal.

### EFFECT

According to embodiments of the present invention, since sensory information is generated according to a standardized protocol, various sensory effects may be generated in one image content.

Additionally, according to embodiments of the present invention, since information on a device for displaying contents is transmitted using a standardized protocol, transaction of sensory information which is not displayable by the device may be prevented.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a sensory information transaction system according to an embodiment of the present invention;

FIG. 2 is a block diagram illustrating a sensory effect extraction apparatus according to the embodiment of FIG. 1;

FIG. 3 is a block diagram illustrating a sensory content providing apparatus according to the embodiment of FIG. 1;

FIG. 4 is a diagram illustrating an example structure of a sensory content request signal according to an embodiment of the present invention;

FIG. 5 is a diagram illustrating an example structure of a sensory effect extraction request signal according to an embodiment of the present invention; and

FIG. 6 is a diagram illustrating a method for transaction of sensory information, according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

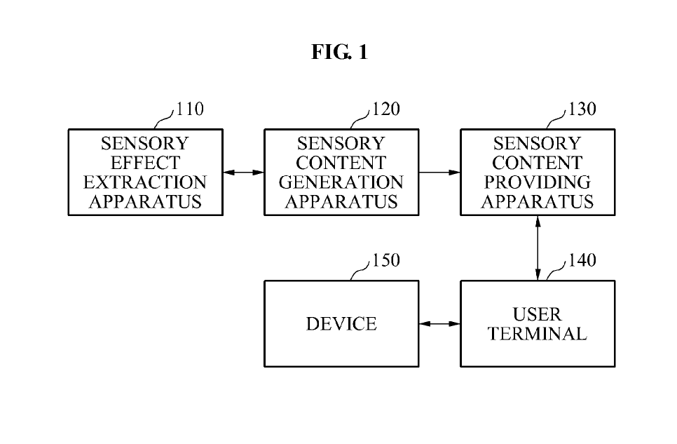

FIG. 1 is a diagram illustrating a sensory information transaction system according to an embodiment of the present invention.

Referring to FIG. 1, the sensory information transaction system includes a sensory effect extraction apparatus 110, a sensory content generation apparatus 120, and a sensory content providing apparatus 130.

According to a request from the sensory content generation apparatus 120, the sensory effect extraction apparatus 110 may extract a sensory effect such as motion, wind, lighting, and the like from an image content, using a sensory effect technology defined by the moving picture expert group (MPEG)-V Part 3. In addition, the sensory effect extraction apparatus 110 may generate sensory information according to the extracted sensory effect. Here, the sensory effect extraction apparatus 110 may provide the generated sensory information to the sensory content generation apparatus 120. The sensory effect extraction apparatus 110 may be a server of a provider of a sensory effect extract service. The request from the sensory content generation apparatus 120 may be a sensory effect extraction request signal in accordance with a standardized protocol.

The sensory content generation apparatus 120 may generate a sensory content by matching the image content with the sensory information. That is, the sensory content generation apparatus 120 may transmit the image content and the sensory effect extraction request signal to the sensory effect extraction apparatus 110, and match the sensory information received from the sensory effect extraction apparatus 110 with the image content. Here, the sensory content generation apparatus 120 may extract the sensory effect directly from the image content and match the extracted sensory effect with the image content.

The sensory content generation apparatus 120 may register the generated sensory content with the sensory content providing apparatus 130 and request sale of the sensory content. In this case, the sensory content generation apparatus 120 may be a server of a sensory content seller who owns the copyright of the image content.

The sensory content providing apparatus 130 may sell the sensory content registered by the sensory content generation apparatus 120 to the user through a user terminal 140. The sensory content providing apparatus 130 may be a transaction server of a sensory content transaction broker.

The user may select a desired sensory content through the user terminal 140 and may be provided with the desired sensory content from the sensory content providing apparatus 130. In addition, the user may execute the sensory content provided by the sensory content providing apparatus 130 in a device 150.

The device 150 may be configured to execute the sensory content. The user terminal 140 may function as the device 150. That is, the sensory content providing apparatus 130 may transmit the sensory content to the user terminal 140 and, therefore, the user terminal 140 may execute the received sensory content, thereby providing the user with the sensory content.

In this instance, the user terminal 140 may transmit, to the sensory content providing apparatus 130, a sensory effect extraction request signal which includes a keyword or identification (ID) information of the desired sensory content, device capability information, and user sensory preference information. Here, the device capability information may be information on performance of the device 150 for displaying the sensory content. The user sensory preference information may be information on at least one sensory effect preferred by the user, among the sensory effects.

Next, the sensory content providing apparatus 130 may search for a sensory content corresponding to the keyword or the ID information among the sensory content registered by the sensory content generation apparatus 120. Also, among sensory information matching the sensory content, the sensory content providing apparatus 130 may search for at least one sensory information which is displayable by the device 150 and includes the sensory effect preferred by the user. Here, the sensory content providing apparatus 130 may provide a list of the searched sensory content, that is, the sensory content list, to the user terminal 140. The sensory content list may include the sensory content and the sensory information being searched.

Next, when the user checks the sensory content list and selects at least one sensory content from the sensory content list, the user terminal 140 may perform a process of purchasing the selected sensory content. Here, the process may include at least one of operations related to paying for the sensory content and providing a license for the sensory content.

Finally, the sensory content providing apparatus 130 may transmit the sensory content purchased by the user to the device 150 and the device 150 may provide the sensory content to the user by displaying the sensory content.

Since the sensory information transaction system according to the embodiment of the present invention generates the sensory information using the standardized protocol, various forms of sensory information may be generated in one image content.

Also, the sensory information transaction system uses the standardized protocol in transmitting the device information about the device for displaying the content. Therefore, a transaction of the sensory information not displayable by the device may be prevented by the sensory information transaction system.

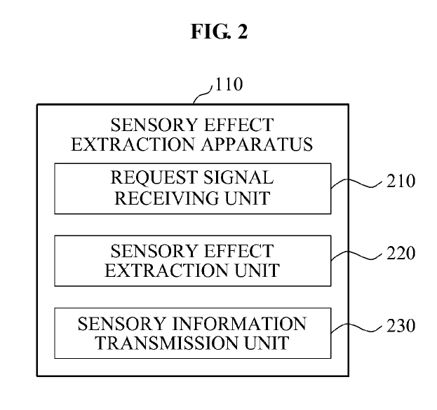

FIG. 2 is a block diagram illustrating the sensory effect extraction apparatus 110 according to the embodiment of FIG. 1.

Referring to FIG. 2, the sensory effect extraction apparatus 110 may include a request signal receiving unit 210, a sensory effect extraction unit 220, and a sensory information transmission unit 230.

The request signal receiving unit 210 may receive a sensory effect extraction request signal from the sensory content generation apparatus 120.

The sensory effect extraction request signal may include at least one selected from position information of the image content from which the sensory content is to be extracted, reference region information to be extracted from the image content, reference time information for extraction of the sensory effect from the image content, and type information of the sensory content to be extracted from the image content, and extension region information corresponding to additional attribute extensions.

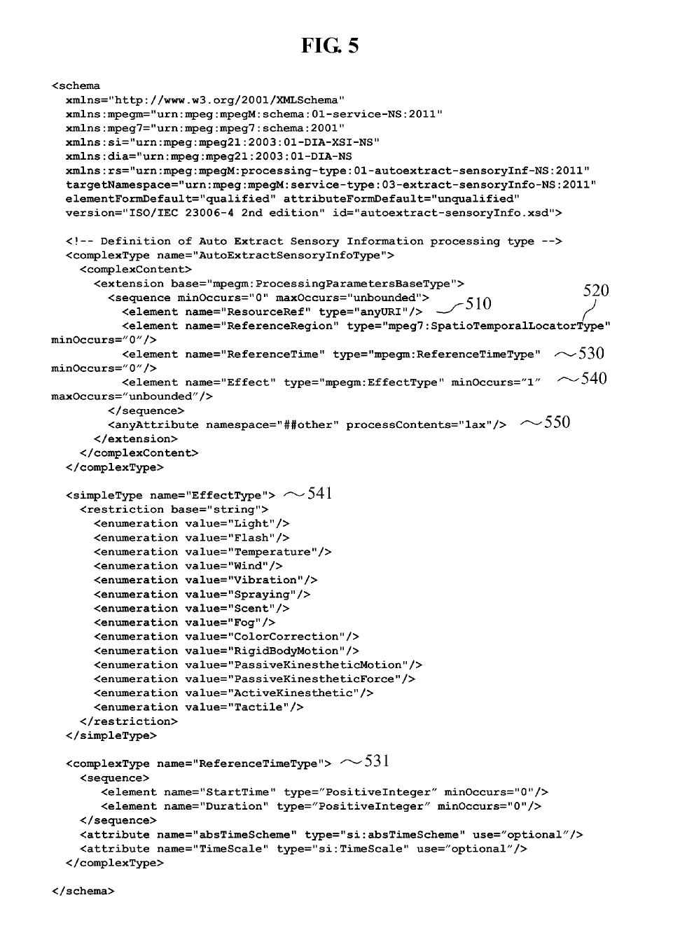

A structure of the sensory effect extraction request signal will be described, as follows, in detail with reference to FIG. 5.

In accordance with the sensory effect extraction request signal received from the request signal receiving unit 210, the sensory effect extraction unit 220 may extract a sensory effect such as motion, wind, lighting, and the like from an image content, using a sensory effect technology defined by the moving picture expert group (MPEG)-V Part 3. Here, the sensory effect extraction unit 220 may generate sensory information based on the sensory effect extracted using sensory information according to international organization for standardization/international electrotechnical commission (ISO/IEC) 23005-3 (MPEG-V Part 3).

The sensory information transmission unit 230 may transmit the sensory information generated by the sensory effect extraction unit 220 to the sensory content generation apparatus 120.

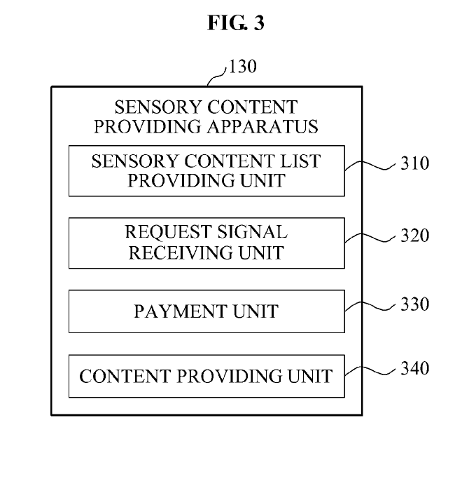

FIG. 3 is a block diagram illustrating the sensory content providing apparatus 130 according to the embodiment of FIG. 1.

Referring to FIG. 3, the sensory content providing apparatus 130 may include a request signal receiving unit 310, a sensory content list providing unit 320, a payment unit 330, and a content providing unit 340.

The request signal receiving unit 310 may receive, from a user terminal, a sensory content request signal which includes a keyword or ID information of a sensory content desired by the user, device capability information, and user sensory preference information.

Here, the device capability information may be control information about performance of a device for displaying the sensory content, the control information according to ISO/IEC 23005-2 (MPEG-V Part 2). The user sensory preference information may be control information on at least one sensory effect preferred by the user, the control information according to ISO/IEC 23005-2 (MPEG-V Part 2).

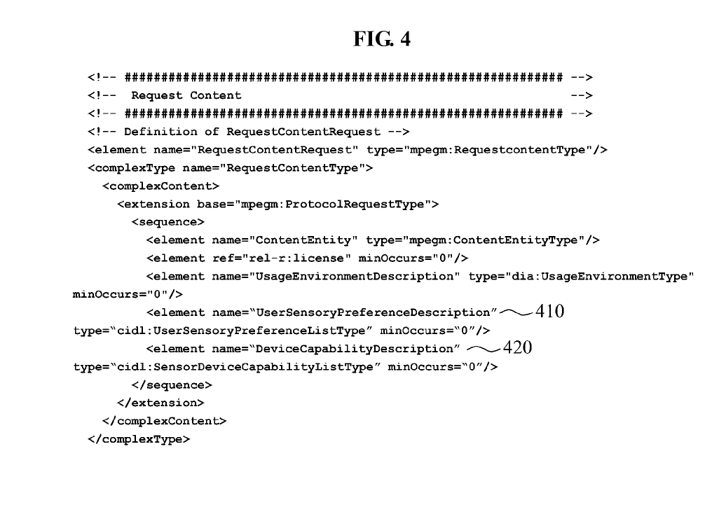

The structure of the sensory content request signal will be described in detail with reference to FIG. 4.

The sensory content list providing unit 320 may search for a sensory content corresponding to the keyword or ID information from the sensory content registered by the sensory content generation apparatus 120. Also, the sensory content list providing unit 320 may search for at least one sensory information which is displayable by the device 150 and includes the sensory effect preferred by the user. Here, the sensory content list providing unit 320 may provide the sensory content list to the user terminal 140, the sensory content list including the sensory content and the sensory information being searched for.

The payment unit 330 may pay for the sensory content and the sensory information selected by the user from the sensory content list, in accordance with a request from the user terminal 140. That is, the payment unit 330 may pay for cost of the sensory content or license of the sensory content.

The content providing unit 340 may provide the user terminal 140 or the device 150 with the sensory content corresponding to the sensory content request signal received by the request signal receiving unit 310 or with the sensory content and sensory information paid for by the payment unit 330.

FIG. 4 is a diagram illustrating an example structure of a sensory content request signal according to an embodiment of the present invention.

As shown in FIG. 4, the sensory content request signal may include UserSensoryPreferenceDescription 410 and DeviceCapabilityDescription 420.

The UserSensoryPreferenceDescription 410 may be a container for the user sensory preference information defined by the MPEG-V Part 2.

The DeviceCapabilityDescription 420 may be a container for the device capability information defined by the MPEG-V Part 2.

FIG. 5 is a diagram illustrating an example structure of a sensory effect extraction request signal according to an embodiment of the present invention.

As shown in FIG. 5, the sensory effect extraction request signal may include ResourceRef 510, ReferenceRegion 520, ReferenceTime 530, Effect 540, and anyAttribute 550.

The ResourceRef 510 may describe a uniform resource identifier (URI) indicating a resource location of the image content such as a video or an image.

The ReferenceRegion 520 may describe a reference region automatically extracted from the image content. The reference region described by the ReferenceRegion 520 may be a region generated according to MPEG 7: SpatioTemporalLocatorType defined by ISO/IEC 15938-5.

The ReferenceTime 530 may describe a reference time mpegm: StartTime and mpegm: Duration for automatic extraction from a resource such as a video or an audio sequence and a time schema using ReferenceTimeType 531. Referring to FIG. 5, the time schema may be described by si: absTimeScheme and si: timescale.

The Effect 540 may describe an effect type to be automatically extracted from the resource according to the ResourceRef 510.

As shown in FIG. 5, an effect type 541 described by the Effect 540 may be at least one selected from Light, Flash, Temperature, Wind, Vibration, Spraying, Scent, Fog, ColorCorrection, RigidBodyMotion, PassiveKinestheticMotion, PassiveKinestheticForce, ActiveKinesthetic, and Tactile.

The anyAttribute 550 may describe an extension region for additional attribute extensions.

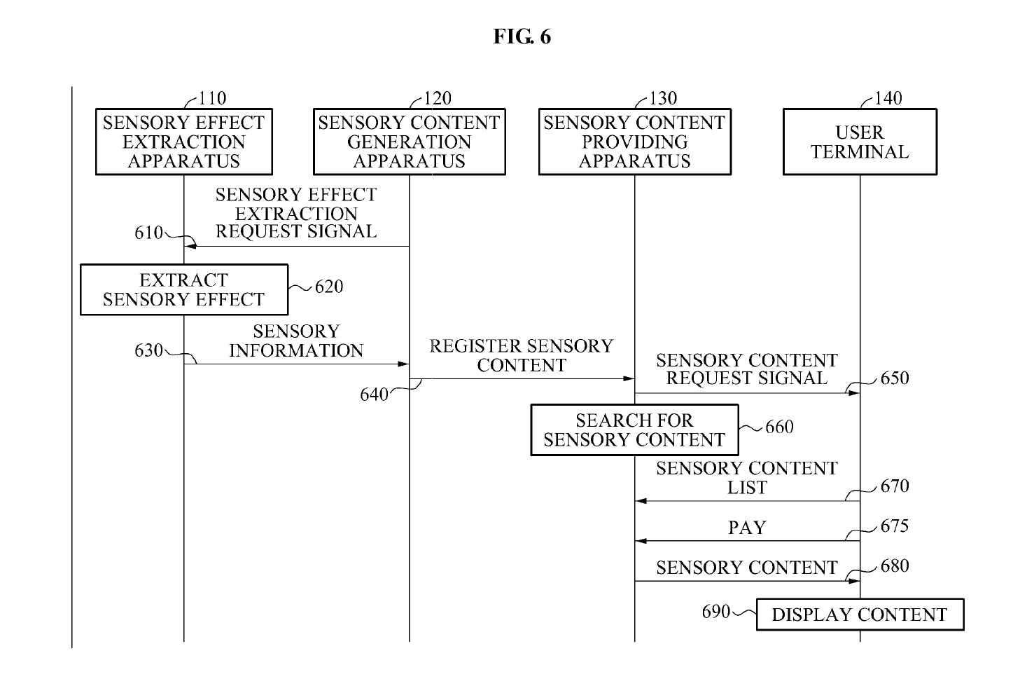

FIG. 6 is a diagram illustrating a method for sensory information transaction, according to an embodiment of the present invention.

In operation 610, the sensory content generation apparatus 120 may transmit the image content and the sensory effect extraction request signal to the sensory effect extraction apparatus 110.

In operation 620, the sensory effect extraction apparatus 110 may extract the sensory effect such as motion, wind, lighting, and the like from the image content in accordance with the sensory effect extraction request signal received in operation 610, and generate the sensory information according to the extracted sensory effect. The sensory effect extraction apparatus 110 may use the sensory effect technology defined by the MPEG-V Part 3.

In operation 630, the sensory effect extraction apparatus 110 may provide the sensory information generated in operation 620 to the sensory content generation apparatus 120.

In operation 640, the sensory content generation apparatus 120 may generate the sensory content by applying the sensory effect to the image content, and register the generated sensory content with the sensory content providing apparatus 130.

In operation 650, the sensory content providing apparatus 130 may receive the sensory content request signal from the user terminal 140, the sensory content request signal including a keyword or ID information of a sensory content desired by the user, device capability information, and user sensory preference information.

In operation 660, the sensory content providing apparatus 130 may search for at least one sensory content corresponding to the sensory content request signal received in operation 650 among the sensory content registered in operation 640.

For example, the sensory content providing apparatus 130 may search for a sensory content corresponding to the keyword or ID information among the sensory content registered in operation 640. Additionally, the sensory content providing apparatus 130 may search for at least one sensory information which is displayable through the user terminal 140 or the device 150 and includes the sensory effect preferred by the user, among the sensory information matching the corresponding sensory content.

In operation 670, the sensory content providing apparatus 130 may provide the user terminal 140 with the sensory content list which is a search result of operation 660.

In operation 675, when the user checks the sensory content list received in operation 670 and selects at least one sensory content or the sensory information corresponding to the sensory content from the sensory content list, the user terminal 140 may pay for the sensory content.

In operation 680, the sensory content providing apparatus 130 may transmit, to the user terminal 140, the sensory content and the sensory information paid for by the user in operation 675. Here, depending on a setting, the sensory content providing apparatus 130 may transmit the sensory content and the sensory information paid for by the user to the device 150 selected by the user.

In operation 690, the user terminal 140 may display the sensory content received in operation 680, thereby providing the user with the sensory content.

Here, the user terminal 140 may apply the sensory information received in operation 680. Also, when the device 150 receives the sensory content in operation 680, the sensory content may be displayed through the device 150.

According to the embodiments described above, since sensory information is generated using a standardized protocol, various sensory effects may be generated in one image content.

Additionally, according to embodiments of the present invention, since information on a device for displaying contents is transmitted using a standardized protocol, transaction of sensory information which is not displayable by the device may be prevented.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A sensory effect extraction apparatus comprising:
a sensory effect extraction unit to extract a sensory effect from an image content in accordance with a sensory effect extraction signal; and
a sensory information transmission unit to transmit sensory information based on the extracted sensory effect.

2. The sensory effect extraction apparatus of claim 1, wherein the sensory effect extraction request signal comprises position information of the image content from which the sensory effect is to be extracted and reference region information to be extracted from the image content.

3. The sensory effect extraction apparatus of claim 1, wherein the sensory effect extraction request signal comprises reference time information for extraction of the sensory effect from the image content.

4. The sensory effect extraction apparatus of claim 1, wherein the sensory effect extraction request signal comprises type information of the sensory effect to be extracted from the image content.

5. The sensory effect extraction apparatus of claim 1, wherein the sensory effect extraction request signal comprises extension region information corresponding to additional attribute extensions.

6. A sensory content providing apparatus comprising:
a request signal receiving unit to receive, from a user terminal, a sensory content request signal which includes device capability information and user sensory preference information; and
a content providing unit to provide the user terminal with a sensory content corresponding to the sensory content request signal.

7. The sensory content providing apparatus of claim 6, wherein the device capability information denotes information on a device for displaying the sensory content.

8. The sensory content providing apparatus of claim 6, wherein the user sensory preference information denotes information on at least one sensory effect preferred by a user among sensory effects.

9. A sensory effect extraction method comprising:
extracting a sensory effect from an image content in accordance with a sensory effect extraction request signal; and
transmitting sensory information based on the extracted sensory effect.

10. The sensory effect extraction method of claim 9, wherein the sensory effect extraction request signal comprises position information of the image content from which the sensory effect is to be extracted and reference region information to be extracted from the image content.

12. The sensory effect extraction method of claim 9, wherein the sensory effect extraction request signal comprises reference time information for extraction of the sensory effect from the image content.

13. The sensory effect extraction method of claim 9, wherein the sensory effect extraction request signal comprises type information of the sensory effect to be extracted from the image content.

14. The sensory effect extraction method of claim 9, wherein the sensory effect extraction request signal comprises extension region information corresponding to additional attribute extensions.

15. A sensory content providing method comprising:
receiving, from a user terminal, a sensory content request signal which includes device capability information and user sensory preference information; and
providing the user terminal with a sensory content corresponding to the sensory content request signal.

16. The sensory content providing method of claim 15, wherein the device capability information denotes information on a device for displaying the sensory content.

17. The sensory content providing method of claim 15, wherein the user sensory preference information denotes information on at least one sensory effect preferred by a user among sensory effects.
